(19) United States
(12) Patent Application Publication
(10) Pub. No.: US 2008/0045491 A1
(43) Pub. Date: Feb. 21, 2008

(54) SURFACE SANITIZER

(76) Inventor: Mark I. Fitchmun, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/838,822

(22) Filed: Aug. 14, 2007

Related U.S. Application Data
(60) Provisional application No. 60/838,092, filed on Aug. 15, 2006.

(51) Int. Cl. A01N 31/00; A01N 31/02; A01N 31/06; A01N 31/08; A01N 37/02; A01N 37/06; A01N 37/36; A01N 37/40; A01N 37/44; A01N 43/08; A01N 55/02; A01N 57/12; A01P 1/00

(52) U.S. Cl. 514/185; 514/474; 514/557; 514/560; 514/561; 514/568; 514/574; 514/721; 514/724; 514/729; 514/731; 514/739; 514/75

(57) ABSTRACT

A non-toxic antimicrobial surface sanitizer composition comprising a water-miscible alcohol, water, a weak acid and a multivalent cation (e.g., metal ion or metal compound). The composition may also include one or more of an emollient, oxidative agent, humectant, lubricant, plant-derived alkene, antimicrobial component or plant-derived essential oil. These compositions can be formulated as solutions for sanitizing hard surfaces such as countertops and floors, or as solutions/gels for application to animal skin.

### RELATED APPLICATIONS

This application claims priority under 35 U.S.C. § 119(e) to U.S. Provisional Application No. 60/838,092, filed Aug. 15, 2006, the entire contents of which are incorporated herein by reference.

### FIELD OF THE INVENTION

The present invention relates to surface sanitizers. More specifically, the invention relates to antimicrobial preparations for sanitizing hard surfaces and skin which comprise an alcohol, water, a weak acid and a multivalent cation.

### BACKGROUND OF THE INVENTION

Antimicrobial cleaners and hand sanitizers are now in widespread use in the United States, as well as other countries around the world. Many products are effective against bacteria. However, most have limited effectiveness against fungi and virus. Thus, there is a need for effective antimicrobial compositions that are non-toxic and effective against a range of pathogenic agents, including bacterial, viruses and fungi. The present invention provides such compositions.

### SUMMARY OF THE INVENTION

The present invention provides a surface sanitizer composition, comprising: a water-miscible alcohol component that constitutes about 50% to 90% of the composition; water that constitutes about 10% to 50% of the composition; an acid component sufficient to maintain the pH of the composition below about 5 which constitutes about 0.1% to about 5% of the composition; and a multivalent cation which constitutes about 0.05% to 5% of the composition. In one embodiment, the acid component comprises one or more weak acids having pKa values between about 2 and about 5. In another embodiment, the water-miscible alcohol component is at least one of ethanol, n-propanol, isopropanol, n-butanol, 2-butanol, isobutanol and tert-butanol. In another embodiment, the water-miscible alcohol component has a dielectric constant that is less than about 23. According to another embodiment, the acid component is at least one of phosphoric acid, acetic acid, propionic acid, citric acid, glycine, malic acid, glycolic acid, salicylic acid, benzoic acid, ascorbic acid and succinic acid. The multivalent cation may be a polymer (e.g., polyamine, polylysine, polyvinylamine, polyethylenimine, chitosan), a metal ion or metal compound. In one embodiment, the metal is at least one of aluminum, bismuth, silver, zinc, boron, selenium and nickel. The metal may be provided in the form of a water-soluble salt, organic compound, inorganic compound, dispersion of finely-divided metal, insoluble salt or compound thereof.

In one embodiment, the metal is provided in the form of zinc chloride. In another embodiment, the metal is provided in the form of a dispersion of finely-divided silver, zinc, zinc oxide, selenium sulfide or bismuth subcitrate. Various additional components may also be included, individually or in any combination. Thus, in one embodiment, the composition further comprises an oxidative agent, such as hydrogen peroxide, peracetic acid or an oxygen radical source. In one aspect of this embodiment, the oxidative agent constitutes about 0.1 to 3% of the composition. The composition may also comprise one or more plant-derived alkenes, such as a terpene or terpenoid. The composition may also further comprise one or more plant-derived essential oils, such as grapefruit oil, marjoram oil, sage oil, vanilla, peppermint oil, cinnamon oil, clove oil, cumin oil, eucalyptus oil, ginger oil, lavender oil, leleshwa oil, lemon oil, mint oil, nigella sativa oil, oregano oil, pine oil, rosemary oil, sandalwood oil and tea tree oil. In another embodiment, the composition of further comprises one or more emollients, a triglyceride rich in fatty acids (e.g., castor oil), a fatty alcohol or a fatty ester. In another embodiment, the composition further comprises one or more humectants, such as glycerol, glyceryl triacetate, propylene glycol, lactic acid, maltitol, sorbitol, quillaia, dimethicone or urea. In yet another embodiment, the composition further comprises one or more lubricants, such as beeswax, jojoba oil, lanolin, almond oil, olive oil or shea butter. The composition may include at least one organic antimicrobial compound. In one embodiment, the organic antimicrobial compound is an alkene (e.g., undecylenic acid, allyl alcohol, sorbic acid), organic acid (e.g., salicylic acid, benzoic acid, phenol), or terpene/terpenoid (e.g., terpineol, terpine-4-ol, thymol). In another embodiment, the organic antimicrobial compound is a dispersion of finely-divided zinc pyrithione or bismuth subcitrate. In other embodiments, the organic antimicrobial compound is a quaternary ammonium compound, an imidazole or triclosan.

The present invention also provides a method of sanitizing a surface, comprising applying any of the compositions described above to the surface. In one embodiment, the surface is a hard surface, such as a countertop, floor, appliance, sink, bathtub or shower. In another embodiment, the surface is a skin surface of a living animal, preferably a mammal or a bird. In one embodiment, the skin is human skin. In another embodiment, the composition is directly applied to the surface. In another embodiment, the composition is placed on or in an applicator or a dispenser, which then applies the composition to the surface. In another embodiment, the applicator or dispenser is a cloth, sponge, mop, squire bottle, spray bottle or pump bottle.

### DETAILED DESCRIPTION OF THE INVENTION

The present invention provides antimicrobial compositions that differ from conventional ethanol/water antimicrobial solutions (e.g., the thickened ethanol/water solution sold under the trademark PURELL® by Gojo Industries, Akron, Ohio) and other antimicrobial preparations, and contain no toxic components. These compositions are suitable for sanitizing hard surfaces, such as countertops, floors, sinks, showers, bathtubs, appliances, and the like. In addition, the compositions can be used to sanitize skin surfaces, such as animal (e.g., human) skin and have superior hand-feel and smell to conventional hand sanitizers. In one embodiment, these compositions are used to sanitize human hands which are the part of the body that most often comes into contact with microbes such as bacteria and viruses, but may also be used to sanitize other parts of the body.

These compositions kill or inactivate a broader range of pathogens (e.g., bacteria, viruses, fungi) than do conventional antimicrobial compositions. For example, the compositions described herein are more effective against acid-labile viruses such as adenovirus types 2, 5 and 8.

In one embodiment, there is provided an antimicrobial composition comprising:
(a) An alcohol component that is miscible with water and constitutes about 50% to 90% of the composition;
(b) Water, which constitutes about 10% to 50% of the composition;
(c) An acid component sufficient to maintain the pH below about 5, which constitutes about 0.1-10%, or about 0.1-5%, of the composition; and
(d) A multivalent cation which constitutes about 0.01% to 5% of the composition.

All percentages are by weight, with reference to the weight of the pure component or metal, not including any water (for the non-water components), solvent, or counter-ion (in the case of metals). Each of these components is described in more detail below.

Alcohol Component

Without wishing to be bound by any particular theory, the alcohol component exerts antimicrobial activity by damaging lipid structures and denaturing proteins of microorganisms. Other mechanisms may also be involved. The alcohol component can comprise one or more water-miscible alcohols, including methanol, ethanol, n-propanol, 2-propanol (isopropanol), n-butanol, 2-butanol, isobutanol and tert-butanol. Formulations comprising n-butanol, and/or isobutanol may also contain one or more lower alcohols (e.g. ethanol, n-propanol, iso-propanol), as n-butanol and isobutanol are not miscible with water in about the 20% to 80% range. In one embodiment, if ethanol is used as the lower alcohol, the butanol/ethanol ratio is in a range of about 1:2 to 2:1.

In one embodiment, methanol, ethanol, n-propanol or isopropanol are used alone, or in any combination. In another embodiment, n-butanol, 2-butanol, isobutanol or tert-butanol is used in combination with one or more of methanol, ethanol, n-propanol or isopropanol.

Formulations containing n-butanol, and/or isobutanol may be undesirable in some applications, as some individuals find their fumes unpleasant smelling, or irritating. Ethanol is less able to hold hydrophobic components in solution than higher alcohols. Formulations containing ethanol may also contain one or more higher alcohols (e.g., n-propanol, isopropanol, n-butanol, isobutanol) if increased solvating power for hydrophobic components such as emollients is needed.

In one embodiment, if n-butanol, and/or isobutanol is/are used as the higher alcohol, the butanol/ethanol ratio is in a range of about 1:2 to 2:1. Isopropanol and n-propanol have better solvating power for hydrophobic components than ethanol, and are water miscible over a wide range of conditions. In one embodiment, the alcohol component is a stronger organic solvent than ethanol.

In another embodiment, the water component is synergistic with the alcohol component.

Acid Component

The main purpose of the acid component is to inactivate alcohol resistant viruses. A pH below about 5 is desirable for virus inactivation, while a pH above about 2 is desirable to reduce the possibility of skin irritation. Thus, in one embodiment, an acid is selected which is capable of maintaining the pH of the composition between about 2 and about 5. These acids preferably include one or more weak acids having pKa values between about 2 and about 5. A weak acid provides additional benefits, such as acting as a pH buffer to help assure batch to batch product consistency, performance over time, and base neutralizing capacity. To provide these effects, an acid (or its conjugate base) may have a pKa between about 2 and 5. Weak acids include, for example, phosphoric acid, acetic acid, propionic acid, citric acid, glycine, malic acid, glycolic acid, salicylic acid, benzoic acid, ascorbic acid and succinic acid. The low volatility of most weak acids allows persistent antiviral protection after volatile components have evaporated. In addition, some weak acids provide benefits other than virus inactivation. For example, the following weak acids provide the following benefits:

salicylate: antifungal, antioxidant, analgesic, anti-inflammatory, exfoliant

ascorbate: antioxidant

benzoate: antifungal, antibacterial

glycolate: exfoliant

propionate: antimicrobial

Some weak acids also provide antifungal activity which may be desirable in settings where yeast and/or mold are problematic. In addition, compositions providing a persistent antibacterial activity may be more effective against spores than alcohol/water alone.

Multivalent Cation Component

The multivalent cation component includes polymers having at least two positive charges such as polyamines (e.g., polyvinylamine, polyethylenimine, putrescine, spermidine, spermine), chitosan, polylysine, metal ions and metal compounds. The polymers have the additional benefit of increasing the viscosity of the solution and/or forming a gel, which is beneficial in the preparation a hand sanitizer. In fact, many conventional thickening agents do not work at low pH. Multivalent cations also lower the infectivity of infectious agents since many such agents have an overall negative charge which interacts noncovalently with the positive charge of the polycation.

The metal ion or metal compound component provides a persistent antimicrobial effect. Ions of selenium, aluminum, bismuth, copper, gold, iron, lead, mercury, silver, zinc, boron, nickel and other metals are toxic to many prokaryotic and eukaryotic microorganisms (including their spores). In addition, some transition metal ions are known to interfere with some virus-cell interactions required for infection. Of course, since copper, lead, and mercury ions are toxic to animals and humans, they would not generally be used in most applications resulting in human contact, such as application to skin, countertops, floors and the like. Aluminum, bismuth, silver, zinc are nontoxic, and can be used in a variety of applications, as compounds, ions, salts, or finely divided (e.g., micron or sub-micron sized) particles. In one embodiment, the metal component comprises aluminum, bismuth, silver, and/or zinc, and may be in the form of water-soluble salts, organic or inorganic compounds, ions, or dispersions of finely-divided metal or dispersions of finely-divided insoluble compounds such as selenium sulfide, zinc pyrithione, zinc oxide and bismuth subcitrate.

Antimicrobial Components

The compositions may include one or more metallic components having antimicrobial activity. These may be the same or different from the multivalent cation. In one embodiment, these components constitute between about 0.02% and 2% of the composition, and include aluminum, boron, bismuth, silver, and/or zinc, and may be in the form of water-soluble salts, organic or inorganic compounds, ions, or dispersions of finely-divided metal or dispersions of finely-divided insoluble compounds such as selenium sulfide, zinc pyrithione, zinc oxide and bismuth subcitrate.

The compositions may also include one or more organic compounds having antibacterial, antifungal and/or antiprotozoal activity. In one embodiment, this component constitutes between about 0.03% and 3% of the composition. These compounds may be synthetic or natural, and include alkenes, organic acids, terpenes and terpenoids. Alkenes include, for example, undecylenic acid, allyl alcohol and sorbic acid. Organic acids include, for example, salicylic acid, benzoic acid and phenol. Terpenes and terpenoids include, for example terpineol (cajaput oil, pine oil), terpinen-4-ol (tea tree oil, essential oil of nutmeg) and thymol. Organic antimicrobial compounds also include a dispersion of finely-divided zinc pyrithione or bismuth subcitrate, quaternary ammonium compounds, imidazoles and triclosan.

Elemental metals (or alloys), organic metallic compounds, and/or inorganic compounds, can be incorporated as suspended solids. Organic metallic compounds, and/or inorganic compounds, as well as soluble salts, can be incorporated as soluble compounds in solution. Examples for suspended components include zinc oxide, metallic silver, and/or bismuth subcitrate. Examples of components in solution include zinc chloride, alum, and/or bismuth sodium tartrate.

The surface sanitizer compositions may also comprise an oxidative agent such as a peroxide (e.g., hydrogen peroxide), peracetic acid or oxygen radical source, one or more plant-derived alkenes, one or more plant-derived essential oils, one or more emollients, one or more humectants and one or more lubricants. In one embodiment, the oxidative agent constitutes about 0.1% to 3% of the composition. In another embodiment, the one or more plant-derived alkenes and/or essential oils constitutes about 0.1 to 3% of the composition. Although the emollients and humectants are intended for use in antimicrobial compositions to be applied to skin, they can also be included in the sanitizers for hard surfaces as described herein.

Emollient Component

Emollients are substances which soften and soothe the skin, and are used to correct dryness and scaling of the skin. They are a key component in the manufacture of lipstick, lotions and other cosmetic products. Compositions comprising emollients are intended for use on human or animal skin. The alcohol concentrations required for effective antimicrobial activity in conventional hand sanitizers can defat human or animal skin causing cracks, irritation, and dermatitis. The addition of emollients can counteract this effect, allowing the skin to remain supple and healthy. Alcohol/water mixtures containing about 10% to 50% water are particularly poor solvents for most compounds commonly used as moisturizers and/or emollients. In general, the more soluble an emollient is in lower alcohols, the more soluble it will be in alcohol/water mixtures. Emollients with good solubility in lower alcohols include, for example, triglycerides rich in hydroxy fatty acids (e.g., castor oil); fatty alcohols such as dodecanol (lauryl alcohol), hexadecanol (cetyl alcohol), and cis-9-octadecen-1-ol (oleyl alcohol); and fatty esters such as methyl palmitate and propyl laurate. In one embodiment, the emollient constitutes between about 0.01 and 0.5% of the composition.

Lubricant Component

The antimicrobial solutions intended for use on human or animal skin described herein may also contain lubricants. These additives can contribute to a good skin feel after the product has been applied. Examples include beeswax, jojoba oil, lanolin, almond oil, olive oil, and shea butter. In one embodiment, the emollient and/or lubricant component constitutes between about 0.01 and 0.5% of the composition.

Humectant Component

A humectant is a hygroscopic substance that often has several hydrophilic groups, most often hydroxyl groups, and forms hydrogen bonds with water molecules, resulting in moisture retention. Compositions comprising humectants are intended for use on human or animal skin. The alcohol concentrations required for effective antimicrobial activity can dehydrate human or animal skin causing cracks, irritation, and dermatitis. The addition of humectants counteracts this effect by attracting and retaining water. Examples of humectants suitable for use in the antimicrobial compositions described herein include glycerol, glyceryl triacetate, propylene glycol, lactic acid, maltitol, sorbitol, quillaia, urea and dimethicone. In one embodiment, the humectant constitutes between about 0.01 and 1% of the composition.

Plant-Derived Alkene and/or Essential Oil Component

Incorporating one or more plant derived alkenes and/or essential oils into the antimicrobial compositions described herein may provide one or more additional benefits, including masking the odors of alcohols, providing pleasant aromas, additional antimicrobial activity, dust suppression, and/or antioxidative activity. Examples of plant-derived alkenes include, for example, terpenes, terpenoids, and organic acids (e.g., salicylic acid, benzoic acid, phenol). Terpenes may be natural or synthetic, and used for their aromatic qualities (e.g., vanillin, linalool, limonene, grapefruit merchantman), anesthetic qualities (e.g., camphor eugenol, menthol) or antimicrobial qualities (terpineol, terpinen-4-ol, thymol).

Examples of essential oils include, for example, grapefruit oil, tangerine oil, marjoram oil, sage oil, vanilla, peppermint oil, cinnamon oil, clove oil, cumin oil, eucalyptus oil, ginger oil, lavender oil, leleshwa oil, lemon oil, mint oil, nigella sativa oil, oregano oil, pine oil, rosemary oil, sandalwood oil, and tea tree oil. In one embodiment, the plant-derived alkene and/or essential oil component constitutes between about 0.02 and 1% of the composition.

The antimicrobial compositions intended for use on human or animal skin may further comprise one or more of the following: an exfoliant, antioxidant, analgesic or anti-inflammatory agent. An exfoliant is a compound that removes dead skin cells from the surface of the skin to reveal the younger, healthier-looking skin underneath. Exfoliants include, for example, salicylic acid, glycolic acid, citric acid, malic acid, and fruit enzymes. Antioxidants neutralize free radicals that can damage skin cells, and include ascorbic acid (vitamin C), tocopherols (vitamin E), alpha lipoic acid, grape seed extract, green tea extract, L-ergothioneine and resveratrol. Examples of analgesics/anti-inflammatory agents include non-steroidal anti-inflammatory agents (e.g., ibuprofen, acetaminophen, ketoprofen, indomethacin, aspirin, and the like) and corticosteroids.

The number of viable microorganisms on a surface can be reduced by directly applying the antimicrobial solution. The solution can be directly applied to hard surfaces using a squirt bottle, spray bottle, pump bottle or the like. In another embodiment, the solution is first be applied to a cloth, sponge, mop, or other applicator device, and then applied to a hard surface using the applicator device. The applicator device can be a disposable device which contains a quantity of the antimicrobial solution, and is provided in a sealed container.

The number of viable microorganisms on a human or animal skin can be reduced by applying a quantity of an antimicrobial solution. The solution can be directly applied to skin using a squirt bottle, spray bottle, or the like. The solution can be first be applied to a cloth, sponge, or other applicator device, and then applied to the skin using the applicator device. The applicator device can be a disposable device which contains a quantity of the antimicrobial solution, and is provided in a sealed container.

One advantage of the antimicrobial compositions described herein is that they can be formulated with a high percentage of plant-derived ingredients. For example, alcohol, the weak acid, and many alkenes or essential oils can all be prepared from natural plant sources.

The antimicrobial compositions can be in any form suitable for application to a hard surface or mammalian skin, including a solution, gel, cream, paste, ointment or lotion. Exemplary, non-limiting compositions follow, in which all percentages are by weight, and modes of action are set forth as non-limiting theories of operation.

### EXAMPLE 1

TABLE 1
Surface sanitizer composition

| Component | % | Purpose | Effects |
|---|---|---|---|
| Isobutanol | 30 | Solvent | Damages lipid membranes of |
| | | | bacteria, yeast, fungi, and |
| | | | envelope viruses. |
| Ethanol | 29 | Co-solvent | Prevents isobutanol and water |
| | | | from forming two phases |
| | | Denaturing | Damages proteins of bacteria, |
| | | | yeast, fungi, and viruses. |
| Water | 37 | Co-solvent | Synergistic with ethanol and |
| | | | isobutanol. |
| | | Carrier | Facilitates delivery of other |
| | | | components. |
| Zinc | 1.5 | Zn⁺⁺ source | Persistent toxin to many bacteria, |
| chloride | | | yeast, and fungi. |
| | | | Interferes with infection process |
| | | | of many viruses. |
| Benzoic | 2.0 | Respiratory | Inhibits anaerobic fermentation in |
| acid | | toxin | many bacteria, yeast, and fungi. |
| | | H⁺ source | Deactivates many capsid viruses. |
| | | pH buffer | Increases base neutralizing |
| | | | capacity, product consistency, |
| | | | and persistence. |
| Tea | 0.5 | Terpene/oid | Masks isobutanol odor |
| tree oil | | source | Antimicrobial |
| | | | Dust suppression |

### EXAMPLE 2

TABLE 2
Hand sanitizer composition

| Component | % | Purpose | Effect |
|---|---|---|---|
| n-Propanol | 62 | Solvent | Damages lipid membranes of bacteria, yeast, fungi, |
| | | | and envelope viruses. |
| | | Denaturing | Damages proteins of bacteria, yeast, fungi, and |
| | | | viruses. |
| Water | 35 | Co-solvent | Synergistic with ethanol and isobutanol. |
| | | Carrier | Facilitates delivery of other components. |
| Zinc chloride | 1.1 | Zn⁺⁺ source: | Persistent toxin to many bacteria, yeast, and fungi. |
| | | | Interferes with infection process of many viruses. |
| Glycolic acid | 0.90 | H⁺ source | Deactivates many capsid viruses. |
| | | pH buffer | Increases base neutralizing capacity, product |
| | | | consistency, and persistence. |
| | | Exfoliant | Improves skin texture and feel. |
| Salicylic acid | 0.90 | H⁺ source | Deactivates many capsid viruses. |
| | | pH buffer | Increases base neutralizing capacity, product |
| | | | consistency, and persistence. |
| | | Salicylate | Antifungal |
| | | source | |
| | | Exfoliant | Improves skin texture and feel. |
| Glycerol | 0.75 | Humectant | Helps counteract drying effects of propanol by |
| | | | helping the skin to attract and retain water |
| Castor bean | 0.22 | Emollient | Counteracts defatting effects of propanol. Reduces |
| oil | | | evaporative water loss from skin. |
| Essential oils | 0.10 | Terpene/oid | Pleasant smelling blend of lemon, geranium, |
| | | source | rosewood, and cedar wood oils; masks propanol |
| | | | odor. |
| Almond oil | 0.015 | Lubricant | Good skin feel |
| Shea oil | 0.015 | Lubricant | Good skin feel |

### EXAMPLE 3

TABLE 3
Hand sanitizer composition (gel)

| Component % | Function | Effect |
|---|---|---|
| Ethanol | Solvent | Damages lipid membranes of bacteria, yeast, fungi, |
| 78 | | and envelope viruses. |
| | Denaturant | Damages proteins of bacteria, yeast, fungi, and |
| | | viruses. |
| Water | Co-solvent | Synergistic with ethanol and Propanol. |
| 13 | Carrier | Solvent for water soluble components |
| n-Propanol | Solvent | Damages lipid membranes of bacteria, yeast, fungi, |
| 6 | | and envelope viruses. |
| | Carrier | Along with ethanol, facilitates delivery water |
| | | insoluble components |
| Essential oils: | Terpene/oid | masks propanol odor, provides pleasant smell, added |
| grapefruit tangerine, | source | antimicrobial activity. |
| marjoram, sage, | | |
| lavender, vanilla, | | |
| peppermint | | |
| 0.5-2.0 | | |
| Salicylic acid | H⁺ source | Deactivates many capsid viruses. |
| 0.5-2.0 | pH buffer | Increases base neutralizing capacity, product |
| | | consistency, and persistence. |
| | Salicylate | Antifungal |
| | source | |
| | Exfoliant | Improves skin texture and feel. |
| Propionic acid | H⁺ source | Deactivates many capsid viruses. |
| 0.1-0.4 | pH buffer | Increases base neutralizing capacity, product |
| | | consistency, and persistence. |
| | Solubilizer | Used to dissolve chitosan |
| Chitosan | Poly cation | Reduces infectivity of bacteria, yeast, and fungi. |
| 0.3-1.5 | | Viscosity/Gelling agent |
| Glycerol | Humectant | Helps counteract drying effects of ethanol by helping |
| 0.04-0.2 | | the skin to attract and retain water |
| Cetyl alcohol | Emollient | Counteracts defatting effects of propanol. Reduces |
| 0.01-0.04 | | evaporative water loss from skin. |
| Castor oil | Emollient | Counteracts defatting effects of propanol. Reduces |
| 0.01-0.04 | | evaporative water loss from skin. |
| Olive oil | Lubricant | Counteracts defatting effects of propanol. Reduces |
| 0.01-0.04 | | evaporative water loss from skin. Good skin feel. |

### EXAMPLE 4

TABLE 4
Hand sanitizer composition (mist)

| Component % | Function | Effect |
|---|---|---|
| Ethanol | Solvent | Damages lipid membranes of bacteria, yeast, fungi, |
| 78 | | and envelope viruses. |
| | Denaturant | Damages proteins of bacteria, yeast, fungi, and |
| | | viruses. |
| Water | Co-solvent | Synergistic with ethanol and Propanol. |
| 13 | Carrier | Solvent for water soluble components |
| n-Propanol | Solvent | Damages lipid membranes of bacteria, yeast, fungi, |
| 6 | | and envelope viruses. |
| | Carrier | Along with ethanol, facilitates delivery water |
| | | insoluble components |
| Essential oils: | Terpene/oid | masks propanol odor, provides pleasant smell, added |
| grapefruit tangerine, | source | antimicrobial activity. |
| marjoram, sage, | | |
| lavender, vanilla, | | |
| peppermint | | |
| 0.5-2.0 | | |
| Salicylic acid | H⁺ source | Deactivates many capsid viruses. |
| 0.5-2.0 | pH buffer | Increases base neutralizing capacity, product |
| | | consistency, and persistence. |
| | Salicylate | Antifungal |
| | source | |
| | Exfoliant | Improves skin texture and feel. |
| Propionic acid | H⁺ source | Deactivates many capsid viruses. |
| 0.1-0.4 | pH buffer | Increases base neutralizing capacity, product |
| | | consistency, and persistence. |
| Zinc chloride | divalent cation | antimicrobial |
| 0.5-2.0 | | |
| Glycerol | Humectant | Helps counteract drying effects of ethanol by helping |
| 0.04-0.2 | | the skin to attract and retain water |
| Cetyl alcohol | Emollient | Counteracts defatting effects of propanol. Reduces |
| 0.01-0.04 | | evaporative water loss from skin. |
| Castor oil | Emollient | Counteracts defatting effects of propanol. Reduces |
| 0.01-0.04 | | evaporative water loss from skin. |
| Olive oil | Lubricant | Counteracts defatting effects of propanol. Reduces |
| 0.01-0.04 | | evaporative water loss from skin. Good skin feel. |

Antimicrobial Assay

An antimicrobial solution was prepared in accordance with the embodiments described herein, the composition of which is shown above (Table 3), and was tested against a conventional hand sanitizer (PURELL®). Efficacy of the compositions was tested against the following five microorganisms: Candida albicans (ATCC #10231), Aspergillus niger (ATCC #16404), Escherichia coli (ATCC #8739), Pseudomonas aeruginosa (ATCC #9027), Staphylococcus aureus (ATCC #6538), and Adenovirus type 5 (Ad5). All of these microorganisms were obtained from the American Type Culture Collection (ATCC), Manassas, Va. Briefly, not less than 10⁶ cfu/0.1 mL of each microorganism was placed on each separate cover slip and the inoculum was allowed to dry at room temperature. To two cover slips of each microorganism, 0.1 mL of Composition A or 0.1 mL of PURELL® was added to the dried inoculum, and the Composition A and PURELL® were allowed to dry at 37° C. All of the cover slips were then placed in 6 well plates, and 2 ml of 0.9% saline was added to each well. The 6 well plates were agitated on an orbital shaker for about 5 minutes. Cover slips with dried inoculum and no hand sanitizer were prepared as above for the positive controls. Negative controls were 0.9% saline. The extract from each was plated on the appropriate media and incubated as appropriate. The log reduction in the number of viable organisms is shown in Table 5.

TABLE 5

| | Example formulation 3 | PURELL ® |
|---|---|---|
| C. albicans | 5.4 | 5.4 |
| A. niger | 4.3 | 3.0 |
| P. aeruginosa | 6.1 | 6.1 |
| S. aureus | 4.6 | 4.6 |
| E. coli | 3.6 | 3.6 |
| Ad5 | 3.1 | 1.8 |

Example formulation 3 reduced the amount of viable A. niger by 21.818-fold, while PURELL® reduced the amount of viable A. niger by only 1111-fold. Similarly, composition A reduced the amount of viable Ad5 by 1259-fold, while PURELL® reduced the amount of viable Ad5 by only 63-fold.

In a modification of the above study, the coverslips were pre-moistened with 0.9% saline in order to simulate real world conditions in food preparation settings. In this study, the effectiveness in killing A. niger fell from modestly to 5455-fold example formulation 3. However, these same conditions rendered PURELL® virtually ineffective.

In another study, the sanitizer was first applied to the coverslips and allowed to dry. The microbes were then applied and allowed to dry. No additional sanitizer was applied. In this study, the residue from example formulation 3 was able to reduce viable S. aureus and E. coli 16 to 20 fold in contrast to 3 to 5 fold for PURELL®.

Although the invention has been described in the context of certain preferred embodiments, it will be understood that the present invention is not limited to only those embodiments. Any embodiment that retains the spirit of the present invention should be considered to be within its scope. However, the invention is only limited by the scope of the following claims.

What is claimed is:

1. An surface sanitizer composition, comprising:
a water-miscible alcohol component that constitutes about 50% to 90% of the composition;
water that constitutes about 10% to 50% of the composition;
an acid component sufficient to maintain the pH of the composition below about 5 which constitutes about 0.1% to about 5% of the composition; and
a multivalent cation which constitutes about 0.05% to 5% of the composition.

2. The composition of claim 1, wherein the acid component comprises one or more weak acids having pKa values between about 2 and about 5.

3. The composition of claim 1, wherein the water-miscible alcohol component is at least one selected from the group consisting of methanol, ethanol, n-propanol, isopropanol, n-butanol 2-butanol, tert-butanol and isobutanol.

4. The composition of claim 1, wherein the weak acid component is at least one selected from the group consisting of phosphoric acid, acetic acid, propionic acid, citric acid, glycine, malic acid, glycolic acid, salicylic acid, benzoic acid, ascorbic acid and succinic acid.

5. The composition of claim 1, wherein the multivalent cation is a polymer.

6. The composition of claim 1, wherein the multivalent cation is a metal ion or metal compound.

7. The composition of claim 6, where the metal is at least one selected from the group consisting of aluminum, bismuth, silver, zinc, boron, selenium and nickel.

8. The composition of claim 7, wherein the metal is provided in the form of a water-soluble salt, organic compound, inorganic compound, dispersion of finely-divided metal, insoluble salt or compound thereof.

9. The composition of claim 6, wherein the metal is provided in the form of zinc chloride.

10. The composition of claim 6, wherein the metal is provided in the form of a dispersion of finely-divided silver, zinc, zinc oxide, selenium sulfide, or bismuth subcitrate

11. The composition of claim 1, further comprising at least one oxidative agent.

12. The composition of claim 11, wherein the oxidative agent is selected from the group consisting of hydrogen peroxide and peracetic acid.

13. The composition of claim 11, wherein the oxidative agent constitutes about 0.1 to 3% of the composition.

14. The composition of claim 1, further comprising at least one plant-derived alkene.

15. The composition of claim 14, wherein the plant-derived alkene is a terpene, or terpenoid.

16. The composition of claim 1, further comprising at least one plant-derived essential oil.

17. The composition of claim 16, wherein the essential oil is selected from the group consisting of grapefruit oil, tangerine oil, marjoram oil, sage oil, vanilla, peppermint oil, cinnamon oil, clove oil, cumin oil, eucalyptus oil, ginger oil, lavender oil, leleshwa oil, lemon oil, mint oil, nigella sativa oil, oregano oil, pine oil, rosemary oil, sandalwood oil and tea tree oil.

18. The composition of claim 1, further comprising at least one emollient.

19. The composition of claim 18, wherein the emollient is a triglyceride rich in fatty acids, a fatty alcohol or a fatty ester.

20. The composition of claim 18, wherein the emollient is castor oil.

21. The composition of claim 1, further comprising at least one humectant.

22. The composition of claim 21, wherein the humectant is selected from the group consisting of glycerol, glyceryl triacetate, propylene glycol, lactic acid, maltitol, sorbitol, dimethicone, quillaia and urea.

23. The composition of claim 1, further comprising at least one lubricant.

24. The composition of claim 23, wherein the lubricant is selected from the group consisting of beeswax, jojoba oil, lanolin, almond oil, olive oil and shea butter

25. The composition of claim 23, wherein the lubricant is olive oil.

26. The composition of claim 1, further comprising at least one organic antimicrobial compound.

27. The composition of claim 26, wherein said organic antimicrobial compound is selected from the group consisting of alkenes, organic acids, terpenes and terpenoids.

28. The composition of claim 27, wherein said alkene, selected from the group containing undecylenic acid, allyl alcohol, and sorbic acid.

29. The composition of claim 27, wherein said organic acid, selected from the group containing salicylic acid, benzoic acid, and phenol.

30. The composition of claim 27, wherein said terpene or terpenoid, is selected from a group containing terpineol, terpinen-4-ol, and thymol.

31. The composition of claim 26, wherein said organic antimicrobial compound is a dispersion of finely-divided zinc pyrithione or bismuth subcitrate.

32. The composition of claim 26, wherein said organic antimicrobial compound is selected from a group containing quaternary ammonium compounds, and imidazoles.

33. The composition of claim 26, wherein said organic antimicrobial compound is triclosan.

34. A method of sanitizing a surface, comprising applying the composition of claim 1 to said surface.

35. The method of claim 34, wherein said surface is a hard surface.

36. The method of claim 35, wherein said hard surface is selected from the group consisting of a countertop, floor, appliance, sink, bathtub or shower.

37. The method of claim 34, wherein said surface is a skin surface.

38. The method of claim 37, wherein said skin is human skin.

39. The method of claim 34, wherein the composition is applied directly to said surface.

40. The method of claim 34, wherein the composition is placed on or in an applicator or dispenser, which then applies the composition to the surface.

41. The method of claim 40, wherein the applicator or dispenser is selected from the group consisting of a cloth, sponge, mop, squirt bottle, spray bottle and pump bottle.

42. The composition of claim 5, wherein said polymer is a polyamine, polylysine, polyvinylamine, polyethylenimine or chitosan.

43. The composition of claim 5, wherein said polymer is chitosan.
